(19) United States
(12) Patent Application Publication
(10) Pub. No.: US 2008/0131801 A1
(43) Pub. Date: Jun. 5, 2008

(54) DEVELOPING AGENT AND METHOD FOR MANUFACTURING THE SAME

(75) Inventors: Motonari Udo, Mishima-shi (JP); Takayasu Aoki, Mishima-shi (JP); Takashi Urabe, Sunto-gun (JP); Tsuyoshi Itou, Izunokuni-shi (JP); Satoshi Araki, Izunokuni-shi (JP); Masahiro Ikuta, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/947,444

(22) Filed: Nov. 29, 2007

Related U.S. Application Data
(60) Provisional application No. 60/868,203, filed on Dec. 1, 2006.

(30) Foreign Application Priority Data
Nov. 22, 2007 (JP) 2007-303321

(51) Int. Cl. G03G 9/087

(52) U.S. Cl. 430/109.1; 430/137.13; 430/137.15

(57) ABSTRACT

A method including polymerization performed with the use of a binder resin dispersion containing a styrene monomer, a compound having one or more unsaturated bond and sulfonic acid or sulfonate, and an acrylic ester monomer, wherein the contents of the monomers and the compound are 60 to 90 mol %, 1 mol ppm to 10 mol %, and 10 to 40 mol %, respectively.

### CROSS-REFERENCE TO RELATED APPLICATIONS

This application claims the benefit of U.S. Provisional Application No. 60/868,203, filed Dec. 1, 2006.

This application is based upon and claims the benefit of priority from prior Japanese Patent Application No. 2007-303321, filed Nov. 22, 2007, the entire contents of which are incorporated herein by reference.

### BACKGROUND OF THE INVENTION

1. Field of the Invention

The present invention relates to a developing agent used to develop an electrostatic charge image and a magnetic latent image in electrophotography, electrostatic printing, magnetography, etc. and a preparation method thereof.

2. Description of the Related Art

A toner is required to have charge stability under both high temperature high humidity and low temperature low humidity, i.e., not to be changeable with the environmental atmosphere. As a measure for reducing the environmental change of a toner, a resin which is small in change of charge quantity and water absorption amount is demanded especially on a toner surface. Hitherto, as one prescription for reducing the environmental change of a toner, it is necessary to use a binder resin having adjusted properties or characteristics. As a method thereof, it is often carried out to increase or decrease the amount of an unsaturated carboxylic acid in emulsion polymerization, thereby controlling an acid value of the resin at a low level as far as possible.

This preparation method makes it possible to adjust a relatively free acid value by increasing or decreasing the amount of the unsaturated carboxylic acid. However, when the acid value is decreased, a yield at the resin preparation is liable to become low.

### BRIEF SUMMARY OF THE INVENTION

The present invention has been made in light of these considerations. The object of the invention is to provide a developing agent which is small in change of charge quantity and water absorption amount by using a binder resin obtained in a high yield.

Another object of the invention is to provide a preparation method of a developing agent which is small in change of charge quantity and water absorption amount by using a binder resin obtained in a high yield.

According to an aspect of the invention, a developing agent includes a coloring agent and a binder resin represented by the following structural formula (1):

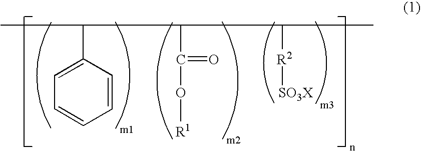

In the formula, n represents an integer, m1=60 to 90%, m2=10 to 40%, m3=1 ppm to 10%, while satisfying m1+m2+m3=100%, and R¹ is hydrogen or a C1 to C18 alkyl group, R² is a C6+ cyclic compound or a C1 to C18 alkyl group, and X is an atom selected from the group consisting of hydrogen, sodium, potassium, and ammonium.

According to another aspect of the invention, a preparation method of a developing agent includes the step of performing polymerization using a binder resin dispersion including 60 to 90 mol % of a styrene monomer, 1 ppm to 10 mol % of a compound having one or more unsaturated bond and a sulfonic acid or sulfonate, and 10 to 40 mol % of an acrylic ester monomer.

Further, the invention can provide a developing agent which is small in change of charge quantity and water absorption amount and high in a yield.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

The single FIGURE is a flow chart illustrating one example of a preparation method of a developing agent according to the present invention.

### DETAILED DESCRIPTION OF THE INVENTION

Hereinafter, an embodiment of the invention will be described in detail using the accompanying drawings as an example.

A developing agent according to the present invention includes a coloring agent and a binder resin. The binder resin is represented by the foregoing structural formula (1), where n represents an integer, m1=60 to 90%, m2=10 to 40%, m3=1 ppm to 10%, while satisfying m1+m2+m3=100%, R¹ is hydrogen or a C1 to C18 alkyl group, R² is a C6+ cyclic compound, e.g., benzene, cyclohexane, naphthalene, anthracene, etc. or a C1 to C18 alkyl group, and X is an atom selected from the group consisting of hydrogen, sodium, potassium, and ammonium.

A preparation method of a developing agent according to the present invention is a method to produce the foregoing developing agent, including a process where polymerization is carried out using a binder resin material dispersion containing a styrene monomer, a compound having one or more unsaturated bonds and sulfonic acid or sulfonate having, and an acrylic ester monomer, where the contents of the monomers and the compound are 60 to 90 mol %, 1 mol ppm to 10 mol %, and 10 to 40 mol %, respectively.

Additionally, in the formula, m1, m2 and m3 represent a ratio of elements in the parentheses. Here, the value does not indicate a mole ratio but a percentage on m1+m2+m3=100%. This is provided to conveniently calculate the contents of the monomers and compound of the binder resin material in the preparation method.

In the present invention, by using a compound having one or more unsaturated double bonds and a sulfonic acid or/and sulfonate in place of a carboxylic acid such as acrylic acid used for a styrene resin or/and a carboxylate, the resin dispersion stability at the synthesis can be enhanced. Also, since the acid value can be controlled to a low level, a resin particle with low water absorption can be synthesized without involving yield reduction.

With respect to the developing agent of the invention, a yield at the binder resin synthesis is satisfactory, drying efficiency at the toner drying step is good, and charge stability of a toner to the environmental atmosphere is favorable.

In the polymerization of the binder rein, by using a compound having one or more unsaturated double bonds and an sulfonic acid or/and sulfonate in an amount of 1 ppm to 10% relative to 10 to 40% of the content of the carboxylic acid such as acrylic acid or/and carboxylate, the resin dispersion stability at the synthesis can be secured, and a yield of 98% or more can be obtained. Also, an electrophotographic toner having an environmental change rate of charge of 0.8% or more and low water absorption can be obtained.

The binder resin dispersion is carried out by emulsion coagulation method to prepare a binder resin particle, and the binder resin particle is coagulated into a coagulated particle. Then, the coagulated particle is covered with a dispersion containing the binder resin particle to form a coating resin layer, i.e., encapsulation of the particle.

In the encapsulation, a yield at the binder resin synthesis is satisfactory, drying efficiency at the toner drying step is enhanced, and charge stability of a toner to the environmental atmosphere is improved.

Further, the resin is capable of reducing the water content at the developing agent during storage.

In the preparation process, a compound having one or more unsaturated double bonds and a sulfonic acid or/and a sulfonate is contained in an amount of 1 ppm to 10 mol %, and desirably 100 ppm or more and not more than 3,000 mol % relative to the whole of monomers.

Hereinafter, the present invention will be described in detail as follows.

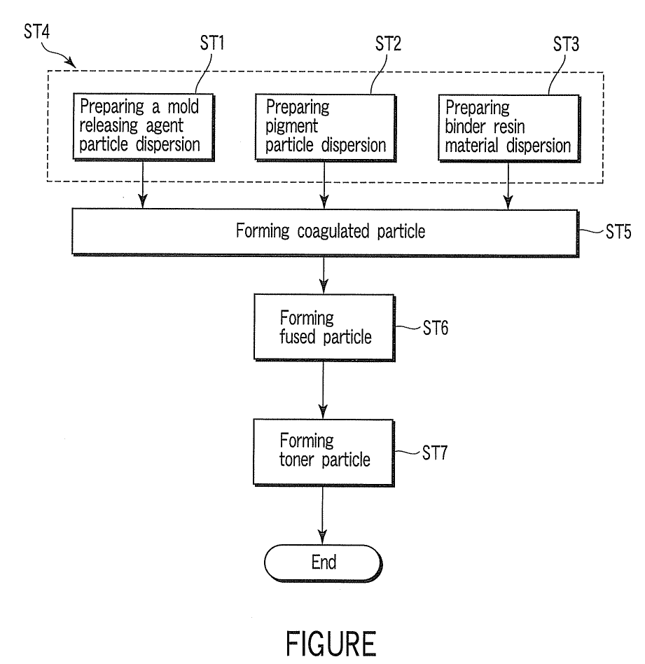

FIG. 1 is a flow chart to illustrate an example of a preparation method of a developing agent according to the present invention.

As illustrated, the preparation method includes a preliminary process (ST4) which has preparation of a mold releasing particle dispersion (ST1), preparation of a pigment particle dispersion (ST2), and preparation of a radical polymerizable monomer (ST3); formation of a coagulated particle (ST5) by mixing, heating, radically polymerizing and coagulating the respective dispersions obtained at the preliminary process (ST4); formation of a fused particle (ST6) by fusing the coagulated particle; and obtaining a toner particle (ST7) by washing and drying the fused particle. Optionally, the method may further include applying an external additive to the surface of the toner particle after the achievement of the toner particle (ST7).

With respect to the binder resin material used for the developing agent of the invention, in the preparation process, a compound having one or more unsaturated double bonds and a sulfonic acid or/and a sulfonate is contained in an amount of not more than 5,000 ppm, and desirably 100 ppm or more and not more than 3,000 ppm relative to the whole of monomers in an aqueous medium containing at least a styrene monomer dispersed therein as a radical polymerizable monomer.

Preparation of Binder Resin Particle

The binder resin particle of the invention can be used as a main ingredient of the toner particle, an external additive of the toner particle, and a material for a core particle or a material for a shell coating layer when the toner particle consists of a core particle and a shell coating layer, respectively.

In the preparation method of the resin, a resin particle is prepared by emulsion polymerization of a radical polymerizable composition containing a styrene monomer as a radical monomer, a compound having one or more unsaturated bonds and a sulfonic acid or sulfonate, and acrylic ether monomer in an aqueous medium. Also, the polymerization can be achieved by emulsion polymerization of the radical polymerizable composition in the presence of a coloring agent or in the presence of at least a mold releasing agent. Furthermore, this resin particle can be deposited as an external agent or/and a shell agent.

This primary particle preferably has a volume average particle size of from 3 μm to 0.01 μm, and more preferably from 1 μm to 0.05 μm. When the volume average particle size is 3 μm or more, the particle size distribution of the ultimately obtained toner is liable to become broad, whereas when it is not more than 0.01 μm, the amount of a dispersant to be used increases.

This method can produce the resin particle having a low acid value in a high yield.

Preparation of Coagulated Particle

The coagulated particle of the invention can be obtained by subjecting the obtained resin particle-containing dispersion, a coloring agent particle-containing dispersion, arbitrary, a releasing agent-containing dispersion, etc. to pH adjustment, heating, addition of a salt, addition of a coagulating agent and the like and relieving or removing repulsion between the particles. According to this, the particle size of the coagulated particle can be grown to a particle size required as the toner.

Preparation of Fused Particle

The fused particle of the invention can be obtained by heating a coagulated particle-containing solution at a Tg or higher of a binder resin or a melting point or higher of a mold releasing agent. However, when encapsulation is performed, there may be the case where this step can be omitted by an encapsulation method as heating for encapsulation and heating for fusion of the coagulated particle can be performed at the same time.

In the invention, after preparing the coagulated particle, encapsulation can be performed as necessary. The encapsulated particle can be obtained by adding a resin particle or the like in the coagulated particle-containing solution, depositing the resin particle or the like on the surface of the coagulated particle and then fusing the resin particle or the like on the surface of the coagulated particle. Also, it is possible to obtain the encapsulated particle by adding the polymerizable monomer in the coagulated particle-containing solution, covering or swelling the surface of the coagulated particle with the monomer and then polymerizing the monomer. Furthermore, it is possible to achieve encapsulation by fusing the coagulated particle, washing and drying the particle and mechanically depositing the resin particle or the like on the surface of the fused particle by using a hybridizer or the like. When the resin particle is used in this encapsulation, the Tg of this resin particle is desirably 50° C. or higher, and more desirably 55° C. or higher. When the Tg is not higher than 50° C., the preservability of the toner becomes worse. When it is higher than 70° C., a fixing temperature is liable to shift as much as 30° C. or more 0.5 parts by weight of titanium oxide (manufactured by Ishihara Sangyo Kaisha, Ltd.) were added based on 100 parts by weight of this dry particle, and the mixture was externally added by a Henschel mixture (manufactured by Mitsui Mining Co., Ltd.) to obtain a toner having a mold releasing agent content of 15%.

### Example 7

Polyester, capsule
Preparation of resin particle

| | |
|---|---|
| Polyester resin | 100 g |
| (Bisphenol A-terephthalic acid adduct, Tg = 61° C., | |
| Mw = 13,000) | |
| Methylene chloride (manufactured by Wako Pure Chemical | 200 g |
| Industries, Ltd.) | |

The foregoing materials were dissolved and dispersed; the dispersion was dispersed in 357 g of ion exchanged water containing 40 g of polyethylene glycol (manufactured by Wako Pure Chemical Industries, Ltd.) and 3 g of an anionic surfactant (Neogen SC-A, manufactured by Dai-ichi Kogyo Seiyaku Co., Ltd.); and an O/W emulsion dispersion was prepared by using a homogenizer (manufactured by IKA Japan K.K.) and then heated to 60° C. to remove the methylene chloride, thereby preparing a resin particle dispersion having a volume average particle size of 500 nm. to higher temperature with respect to a fixing temperature of a copy machine or the like, e.g., about 120° C. to 150° C.

Used Materials

As materials to be used in the invention, all of known materials for toner inclusive of polymerizable monomers, chain transfer agents, crosslinking agents, polymerization initiators, emulsifiers, coagulating agents, resins, coloring agents and mold releasing agents can be used.

The polymerizable monomer to be used in the invention includes following radical polymerizable monomers.

As the styrenic monomer, aromatic based vinyl monomers such as styrene, methylstyrene, methoxystyrene, phenylstyrene and chlorostyrene; as acrylate monomers such as methyl acrylate, ethyl acrylate, butyl acrylate, methyl methacrylate, ethyl methacrylate and butyl methacrylate; carboxylic acid-containing monomers such as acrylic acid, methacrylic acid, fumaric acid and maleic acid; amine based monomers such as amino acrylate, acrylamide, methacrylamide, vinylpyridine and vinyl-pyrrolidone; and derivatives thereof can be used singly or in admixture of plural kinds thereof.

The radical polymerizable monomer-containing dispersion may further include a chain transfer agent. As the chain transfer agent, carbon tetrabromide, dodecylmercaptane, trichlorobromomethane, dodecanethiol, and 3-mercaptopropionic esters are used.

The radical polymerizable monomer-containing solution may further include a crosslinking agent. As the crosslinking agent, compounds having two or more unsaturated bonds such as divinylbenzene, divinyl ether, divinylnaphthalene and diethylene glycol methacrylate are used.

The polymerization initiator must be used different depending upon the polymerization method and includes two kinds of a water-soluble initiator and an oil-soluble initiator. As the water-soluble initiator, persulfates such as potassium persulfate and ammonium persulfate, azo based compounds such as 2,2-azobis(2-aminopropane), hydrogen peroxide, benzoyl peroxide and the like are used. Also, as the oil-soluble initiator, azo based compounds such as azobisisobutyronitrile and azobisdimethylvaleronitrile and peroxides such as benzoyl peroxide and dichlorobenzoyl peroxide are used. Also, if desired, iron (II) bisulfite ion, alcohol, polyamine, vitamin C or the like are used as a redox based initiator.

As the dispersant, anionic surfactants, cationic surfactants, nonionic surfactants and the like can be used.

In particular, sulfuric acid esters, sulfonates, phosphoric esters and the like can be used as the anionic surfactant; amine salts, quaternary ammonium salts and the like can be used as the cationic surfactant; and polyethylene glycols, alkylphenol ethylene oxide adducts and polyhydric alcohols can be used as the nonionic surfactant singly or in combination of plural kinds thereof.

As the binder resin, polyester resins, polystyrene resins, styrene-acrylate copolymers, epoxy resins, and admixtures of plural kinds thereof can be used.

As the coloring agent, carbon black or organic or inorganic pigments are used. In particular, acetylene black, furnace black, thermal black, channel black, ketjen black or the like are used as the carbon black; and first yellow G, bendizine yellow, india first orange, irgazin red, carmine FB, carmine 6 B, permanent bold FRR, pigment orange R, lysol red 2 G, lake red C, rhodamine FB, rhodamine B lake, phthalocyanine blue, pigment blue, brilliant green B, phthalocyanine green, quinacridone, or admixtures of plural kinds thereof are used as the pigment.

As the mold releasing agent, natural waxes such as rice wax, carnauba wax or the like, petroleum waxes such as paraffin wax or the like, and synthetic waxes such as fatty acid ethers, fatty acid amides, low molecular polyethylene, low molecular polypropylene or the like are used.

### EXAMPLES

The present invention will be explained in detail as follows with reference to Examples.

### Example 1

Sodium styrenesulfonate
Preparation of resin particle

| | |
|---|---|
| Styrene | 300 g |
| Butyl acrylate | 36 g |
| Sodium p-styrenesulfonate | 0.045 g |
| 2-Ethylhexyl 3-mercaptopropionate ester | 13.5 g |

The foregoing materials were mixed, the mixture was dispersed and emulsified in a solvent prepared by dissolving 1.8 g of a nonionic surfactant, polyoxyethylene alkyl ether, (Sannonic SS-70, manufactured by Sanyo Chemical Industries, Ltd.) and 3 g of an anionic surfactant (Neogen SC-A manufactured by Dai-ichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 37,000 was obtained.

For the measurement of molecular weight, Waters' 2695 and 2414 were used.

Also, Tg was measured with Thermo Plus DSC 8230 (Rigaku).

Furthermore, as a result of analysis of the obtained particle by GSX-400 NMR spectrometer manufactured by JEOL Ltd., the resin had a structure represented by the following formula (2):

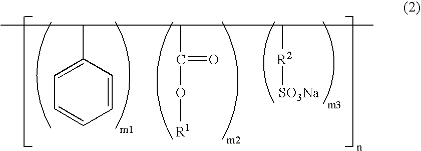

In the formula, m1=76.9%, m2=23.1%, m3=100 ppm, R¹ represents a normal butyl group, R² represents a benzene ring and X represents sodium.

Preparation of Coloring Agent Dispersion

### Carbon black (manufactured by Cabot Corporation 100 g

Anionic surfactant (e.g. Neogen SC-A manufactured by Dai-ichi Kogyo Seiyaku Co., Ltd.) 10 g

### Ion exchanged water 390 g

The foregoing materials were dispersed by using a homogenizer (manufactured by IKA Japan K.K.) to prepare a coloring agent dispersion having a volume average particle size of 150 nm.

Preparation of mold releasing agent particle
dispersion

| | |
|---|---|
| Rice wax (melting point: 80° C., manufactured by Toakasei | 100 g |
| Co., Ltd.) | |
| Anionic surfactant (e.g. Neopelex G15 manufactured by | 10 g |
| Kao Corporation) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 95° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours, to obtain a toner particle having a volume average particle size of 5.0 μm. 3 parts by weight of silica (manufactured by Nippon Aerosil Co., Ltd.) and 0.5 parts by weight of titanium oxide (manufactured by Ishihara Sangyo Kaisha, Ltd.) were added based on 100 parts by weight of this dry particle, and the mixture was externally added by a Henschel mixture (manufactured by Mitsui Mining Co., Ltd.) to obtain a toner having a mold releasing agent content of 15%.

For the measurement of volume average particle size, Multisizer 2 manufactured by Beckman Coulter, Inc., was used.

### Comparative Example 1

Preparation of resin particle

| | |
|---|---|
| Styrene | 295.55 g |
| Butyl acrylate | 36 g |
| Sodium styrenesulfonate | 4.5 g |
| 2-Ethylhexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (manufactured by Daiichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 35,000 was obtained.

Preparation of coloring agent dispersion

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of mold releasing agent particle dispersion

| | |
|---|---|
| Rice wax (melting point: 80° C., manufactured by | 100 g |
| Toakasei Co., Ltd.) | |
| Anionic surfactant (Neopelex G15, manufactured by Kao | 10 g |
| Corporation) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 65° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours to obtain a toner particle having a volume average particle size of 5.0 μm. 3 parts by weight of silica (manufactured by Nippon Aerosil Co., Ltd.) and 0.5 parts by weight of titanium oxide (manufactured by Ishihara Sangyo Kaisha, Ltd.) were added based on 100 parts by weight of this dry particle, and the mixture was externally added by a Henschel mixture (manufactured by Mitsui Mining Co., Ltd.) to obtain a toner having a mold releasing agent content of 15%.

### Example 2

Sulfuric acid based dispersion stabilizer

Sulfuric acid based dispersion stabilizer
Preparation of resin particle

| | |
|---|---|
| Styrene | 300 g |
| Butyl acrylate | 36.0 g |
| Anionic surfactant: sodium sulfate polyoxyethylene | 0.225 g |
| alkyl ether (LATEMUL PD-104, manufactured by Kao | |
| Corporation) | |
| n-Hexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 819.82 g of ion exchanged water. After being displaced with nitrogen and then sealed with nitrogen, the temperature was increased to 75° C., and 20 g of a 10% ammonium persulfate solution was added. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and an Mw of 32,000 was obtained.

Preparation of coloring agent dispersion

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of mold releasing agent particle dispersion

| | |
|---|---|
| Rice wax (melting point: 80° C., manufactured by | 100 g |
| Toakasei Co., Ltd.) | |
| Anionic surfactant (Neopelex G15, manufactured by Kao | 10 g |
| Corporation) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 65° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours to obtain a toner particle having a volume average particle size of 5.0 μm. 3 parts by weight of silica (manufactured by Nippon Aerosil Co., Ltd.) and 0.5 parts by weight of titanium oxide (manufactured by Ishihara Sangyo Kaisha, Ltd.) were added based on 100 parts by weight of this toner particle, and the mixture was externally added by a Henschel mixture (manufactured by Mitsui Mining Co., Ltd.) to deposit the silica particles and the titanium oxide particles on the surface of the toner particles thereby obtaining a toner having a mold releasing agent content of 15%.

### Comparative Example 2

Low in acrylic acid

Preparation of resin particle

Low in acrylic acid
Deteriorated in yield
Preparation of resin particle

| | |
|---|---|
| Styrene | 300 g |
| Butyl acrylate | 36 g |
| Acrylic acid | 0.045 g |
| n-Hexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 820 g of ion exchanged water. After being sealed with nitrogen, the temperature is increased to 75° C., and 20 g of a 10% ammonium persulfate solution is added. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 35,000 was obtained.

Preparation of coloring agent dispersion

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of mold releasing agent particle
dispersion

| | |
|---|---|
| Rice wax (melting point: 80° C., manufactured by | 100 g |
| Toakasei Co., Ltd.) | |
| Anionic surfactant (Neogen SC-A, manufactured by Kao | 10 g |
| Corporation) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 65° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours to obtain a toner particle having a volume average particle size of 5.0 μm. 3 parts by weight of silica (manufactured by Nippon Aerosil Co., Ltd.) and 0.5 parts by weight of titanium oxide (manufactured by Ishihara Sangyo Kaisha, Ltd.) were added based on 100 parts by weight of this dry particle, and the mixture was externally added by a Henschel mixture (manufactured by Mitsui Mining Co., Ltd.) to obtain a toner having a mold releasing agent content of 15%.

### Example 3

Preparation acid based dispersion stabilizer 2

Sulfuric acid based dispersion stabilizer 2
Preparation of resin particle

| | |
|---|---|
| Styrene | 300 g |
| Butyl acrylate | 36 g |
| Anionic surfactant (Adekaria Soap SR-10, | 0.225 g |
| manufactured by Asahi Denka Co., Ltd.) | |
| 2-Ethylhexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 819.82 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 32,000 was obtained.

Preparation of coloring agent dispersion

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of mold releasing agent particle
dispersion

| | |
|---|---|
| Rice wax (melting point: 80° C., manufactured by Toakasei | 100 g |
| Co., Ltd.) | |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 65° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours to obtain a toner particle having a volume average particle size of 5.0 μm. 3 parts by weight of silica (manufactured by Nippon Aerosil Co., Ltd.) and 0.5 parts by weight of titanium oxide (manufactured by Ishihara Sangyo Kaisha, Ltd.) were added based on 100 parts by weight of this toner particle, and the mixture was externally added by a Henschel mixture (manufactured by Mitsui Mining Co., Ltd.) to deposit the silica particles and the titanium oxide particles on the surface of the toner particles thereby obtaining a toner having a mold releasing agent content of 15%.

### Comparative Example 3

Preparation of resin particle

| | |
|---|---|
| Styrene | 295.55 g |
| Butyl acrylate | 36 g |
| Acrylic acid | 4.5 g |
| 2-Ethylhexyl 3-mercaptopropionate ester | 13.5 g |

The foregoing were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (manufactured by Daiichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 39,000 was obtained.

Preparation of coloring agent dispersion

| | |
|---|---|
| Carbon black (manufactured by Cabot Corporation) | 100 g |
| Anionic surfactant (Neogen SC-A, manufactured by | 10 g |
| Dai-ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of mold releasing agent particle
dispersion

| | |
|---|---|
| Rice wax (melting point: 80° C., manufactured by Toakasei | 100 g |
| Co., Ltd.) | |
| Anionic surfactant (Neogen SC-A, manufactured by Kao | 10 g |
| Corporation) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 65° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours to obtain a toner particle having a volume average particle size of 5.0 μm. 3 parts by weight of silica (manufactured by Nippon Aerosil Co., Ltd.) and 0.5 parts by weight of titanium oxide (manufactured by Ishihara Sangyo Kaisha, Ltd.) were added based on 100 parts by weight of this dry particle, and the mixture was externally added by a Henschel mixture (manufactured by Mitsui Mining Co., Ltd.) to deposit the silica particles and the titanium oxide particles on the surface of the toner particles thereby obtaining a toner having a mold releasing agent content of 15%.

### Example 4

Preparation of resin particle

| | |
|---|---|
| Styrene | 299.595 g |
| Butyl acrylate | 36 g |
| Sodium p-styrenesulfonate | 0.45 g |
| 2-Ethylhexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 39,000 was obtained.

Preparation of coloring agent dispersion

| | |
|---|---|
| Carbon black (manufactured by Cabot Corporation) | 100 g |
| Anionic surfactant (Sannonic SS-70, manufactured by | 10 g |
| Dai-ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of mold releasing agent particle
dispersion

| | |
|---|---|
| Rice wax (melting point: 80° C., manufactured by Toakasei | 100 g |
| Co., Ltd.) | |
| Anionic surfactant (Neogen SC-A manufactured by Dai- | 10 g |
| ichi Kogyo Seiyaku Co., Ltd.) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 95° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours to obtain a toner particle having a volume average particle size of 5.0 μm. 3 parts by weight of silica (manufactured by Nippon Aerosil Co., Ltd.) and 0.5 parts by weight of titanium oxide (manufactured by Ishihara Sangyo Kaisha, Ltd.) were added based on 100 parts by weight of this dry particle, and the mixture was externally added by a Henschel mixture (manufactured by Mitsui Mining Co., Ltd.) to deposit the silica particles and the titanium oxide particles on the surface of the toner particles thereby obtaining a toner having a mold releasing agent content of 15%.

### Comparative Example 4

Preparation of resin particle

| | |
|---|---|
| Styrene | 300.04 g |
| Butyl acrylate | 36 g |
| Sodium p-styrenesulfonate | 0.0045 g |
| 2-Ethylhexyl 3-mercaptopropionate ester | 13.5 g |

The foregoing were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C. and Mw of 35,000 was obtained.

Preparation of coloring agent dispersion

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of mold releasing agent particle
dispersion

| | |
|---|---|
| Rice wax (melting point: 80° C., manufactured by Toakasei | 100 g |
| Co., Ltd.) | |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 65° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours to obtain a toner particle having a volume average particle size of 5.0 μm. 3 parts by weight of silica (manufactured by Nippon Aerosil Co., Ltd.) and 0.5 parts by weight of titanium oxide (manufactured by Ishihara Sangyo Kaisha, Ltd.) were added based on 100 parts by weight of this dry particle, and the mixture was externally added by a Henschel mixture (manufactured by Mitsui Mining Co., Ltd.) to deposit the silica particles and the titanium oxide particles on the surface of the toner particles thereby obtaining a toner having a mold releasing agent content of 15%.

### Example 5

Preparation of external additive resin particle

| | |
|---|---|
| Methyl methacrylate (MMA) | 300 g |
| Butyl acrylate | 36 g |
| Sodium p-styrenesulfonate | 0.045 g |
| 2-Ethylhexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 31,000 was obtained.

Preparation of resin particle for toner

| | |
|---|---|
| Styrene | 295.55 g |
| Butyl acrylate | 36 g |
| Acrylic acid | 4.5 g |
| 2-Ethylhexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 320.0 g of ion exchanged water. After being displaced with nitrogen and then sealed with nitrogen, the temperature was increased to 75° C., and 20 g of a 10% ammonium persulfate solution was added thereto. After stirring at 75° C. for 4 hours, 10 g of a 10% ammonium persulfate solution was first added, and 15 g of a 10% sodium hydrogensulfite solution was subsequently added. As a result of emulsion polymerization at 75° C. for 7 hours, an emulsified resin particle dispersion having a volume average particle size of 100 nm, Tg of 60° C., and Mw of 39,000 was obtained.

Preparation of coloring agent dispersion

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of mold releasing agent particle
dispersion

| | |
|---|---|
| Rice wax (melting point: 80° C., manufactured by Toakasei | 100 g |
| Co., Ltd.) | |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 65° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours to obtain a dry particle having a volume average particle size of 5.0 μm. 3% by weight of the washed and dried external additive resin particle, 3% by weight of silica (manufactured by Nippon Aerosil Co., Ltd.) and 0.5% by weight of titanium oxide (manufactured by Ishihara Sangyo Kaisha, Ltd.) were added based on 100% by weight of this dry particle, and the mixture was externally added by a Henschel mixture (manufactured by Mitsui Mining Co., Ltd.) to obtain a toner having a mold releasing agent content of 15%.

### Comparative Example 5

Preparation of external additive resin particle

| | |
|---|---|
| Methyl methacrylate (MMA) | 299.55 g |
| Butyl acrylate | 36 g |
| Acrylic acid | 0.45 g |
| 2-Ethylhexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 30,000 was obtained.

Preparation of resin particle for toner

| | |
|---|---|
| Styrene | 295.55 g |
| Butyl acrylate | 36 g |
| Acrylic acid | 4.5 g |
| 2-Ethylhexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 320.0 g of ion exchanged water. After being displaced with nitrogen and then sealed with nitrogen, the temperature was increased to 75° C., and 20 g of a 10% ammonium persulfate solution was added thereto. After stirring at 75° C. for 4 hours, 10 g of a 10% ammonium persulfate solution was first added, and 15 g of a 10% sodium hydrogensulfite solution was subsequently added. As a result of emulsion polymerization at 75° C. for 7 hours, an emulsified resin particle dispersion having a volume average particle size of 100 nm, Tg of 60° C., and Mw of 39,000 was obtained.

Preparation of coloring agent dispersion

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of mold releasing agent particle
dispersion

| | |
|---|---|
| Rice wax (melting point: 80° C., manufactured by Toakasei | 100 g |
| Co., Ltd.) | |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of coagulated particle

| | |
|---|---|
| Resin particle dispersion | 313 g |
| Coloring agent dispersion | 56 g |
| Mold releasing agent particle dispersion | 120 g |

The foregoing materials were uniformly dispersed by using a homogenizer (manufactured by IKA Japan K.K.), 10 g of ion exchanged water containing polyaluminum chloride (manufactured by Central Glass Co., Ltd.) was additionally added, and the mixture was kept at 50° C. for 1 hour while gently stirring, to obtain a coagulated particle having a volume average particle size of 5.0 μm.

Preparation of Fused Particle

The foregoing coagulated particle dispersion was heated to 65° C. and kept for 5 hours.

Preparation of Toner Particle

The foregoing fused particle was repeatedly subjected to washing with ion exchanged water and filtration; the moisture of the particle was thoroughly removed by filtration; and the resulting particle was dried by a vacuum dryer for 10 hours to obtain a dry particle having a volume average particle size of 5.0 μm. 3% by weight of the washed and dried external additive resin particle, 3% by weight of silica (manufactured by Nippon Aerosil Co., Ltd.) and 0.5% by weight of titanium oxide (manufactured by Ishihara Sangyo Kaisha, Ltd.) were added based on 100% by weight of this Toner particle, and the mixture was externally added by a Henschel mixture (manufactured by Mitsui Mining Co., Ltd.) to obtain a toner having a mold releasing agent content of 15%.

### Example 6

Encapsulation
Preparation of mold releasing agent particle

| | |
|---|---|
| Rice wax (melting point: 80° C., manufactured by Toakasei | 100 g |
| Co., Ltd.) | |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of pigment particle

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of resin particle

| | |
|---|---|
| Styrene | 300 g |
| Butyl acrylate | 36 g |
| Acrylic acid | 4.5 g |
| Dodecanethiol | 13.5 g |

The foregoing were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 811.2 g of ion exchanged water. After being sealed with nitrogen, when the temperature was increased to 75° C., 20 g of a 10% ammonium persulfate solution was added thereto. Thereafter, the monomer dispersion was added dropwise over 3 hours.

Preparation of coagulated particle

| | |
|---|---|
| Resin particle dispersion | 426 g |
| Wax particle dispersion | 64 g |
| Coloring agent dispersion | 64 g |

After being sealed with nitrogen, the foregoing materials were mixed. 10 g of a 10% ammonium persulfate solution was added at 50° C. while adequately stirring, and thereafter, 50 g of a 10% iron (II) sulfate aqueous solution was gently added. As a result of keeping at 50° C. for 1 hour and at 60° C. for 1 hour while gently stirring, a coagulated particle having a volume average particle size of 5.1 μm was obtained.

Preparation of resin particle for capsule

| | |
|---|---|
| Styrene | 300 g |
| Butyl acrylate | 36 g |
| Sodium p-styrenesulfonate | 0.045 g |
| 2-Ethylhexyl 3-mercaptopropionate ester | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 37,000 was obtained.

Preparation of Encapsulated Particle

50 g of a 10% aluminum sulfate aqueous solution was gently added at 50° C. while adequately stirring. As a result of keeping at 50° C. for 1 hour and at 55° C. for 1 hour while gently stirring, a hetero-coagulated particle having a volume average particle size of 5.3 μm was obtained.

Preparation of Fused Particle

The foregoing encapsulated particle dispersion was heated to 75° C. while gently stirring and kept for 30 minutes.

Preparation of Toner Particle

The foregoing fused particle was allowed to stand, separated from a supernatant and then repeatedly subjected to washing with ion exchanged water and filtration. After thoroughly removing the moisture, the resulting particle was dried by a vacuum dryer for 10 hours to obtain a dry particle having a volume average particle size of 5.3 μm. As a result of observing a cross-section of this dry particle by SEM, a continuous and uniform capsule structure was confirmed. 3% by weight of silica (manufactured by Nippon Aerosil Co., Ltd.) and 0.5% by weight of titanium oxide (manufactured by Ishihara Sangyo Kaisha, Ltd.) were added based on 100% by weight of this dry particle, and the mixture was externally added by a Henschel mixture (manufactured by Mitsui Mining Co., Ltd.) to obtain a toner having a mold releasing agent content of 15%.

### Comparative Example 6

Encapsulation
High in environmental change
Preparation of mold releasing agent particle

| | |
|---|---|
| Rice wax (melting point: 80° C., manufactured by Toakasei | 100 g |
| Co., Ltd.) | |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed while heating to about 90° C. by using a homogenizer (manufactured by IKA Japan K.K.), and the dispersion

TABLE 2
Results

| | Resin properties | | | | | | | Toner |
|---|---|---|---|---|---|---|---|---|
| | Basic | Polar group | Polar group | Yield, | Water content, | Toner, q/m | | Environmental |
| | monomer | derivative | derivative, wt % | wt % | wt % | L/L | H/H | change rate |
| Example 1 | Styrene | Sodium | 0.0134 | 98.1 | 30.56 | 35.0 | 32.1 | 0.92 |
| | | styrene-sulfonate | | | | | | |
| Example 2 | Styrene | LATEMUL PD-104 | 0.0134 | 98.1 | 30.61 | 35.1 | 32.0 | 0.91 |
| Example 3 | Styrene | SR-10 | 0.0134 | 98.2 | 30.57 | 35.1 | 31.9 | 0.91 |
| Example 4 | Styrene | Sodium | 0.134 | 98.2 | 34.59 | 34.9 | 31.8 | 0.91 |
| | | styrene-sulfonate | | | | | | |
| Example 5 | MMA | Sodium | 0.0136 | 99.1 | 30.92 | 34.7 | 28.1 | 0.81 |
| | | styrene-sulfonate | | | | | | |
| Example 6 | Styrene | Sodium | 1.36 | 98.4 | 34.67 | 34.8 | 32.1 | 0.92 |
| | | styrene-sulfonate | | | | | | |
| Example 7 | Styrene | Sodium | 0.0134 | 98.1 | 30.56 | 35.1 | 32.2 | 0.92 |
| | | styrene-sulfonate | | | | | | |
| Comparative | Styrene | Sodium | 1.36 | 98.4 | 35.67 | 34.2 | 24.8 | 0.73 |
| Example 1 | | styrene-sulfonate | | | | | | |
| Comparative Example 2 | Styrene | Acrylic acid | 0.0134 | 70.0 | 31.82 | 35.2 | 32.2 | 0.91 |
| Comparative Example 3 | Styrene | Acrylic acid | 1.36 | 98.1 | 32.25 | 34.7 | 26.4 | 0.76 |
| Comparative Example 4 | Styrene | Sodium | 0.00134 | 68.2 | 30.22 | 35.2 | 32.3 | 0.92 |
| | | styrene-sulfonate | | | | | | |
| Comparative Example 5 | MMA | Sodium | 1.36 | 99.2 | 37.14 | 33.9 | 21.3 | 0.63 |
| | | styrene-sulfonate | | | | | | |
| Comparative Example 6 | Styrene | Sodium | 0.00134 | 68.2 | 30.22 | 34.0 | 24.8 | 0.73 |
| | | styrene-sulfonate | | | | | | |
| Comparative Example 7 | Styrene | Sodium | 1.36 | 99.2 | 37.14 | 34.2 | 24.9 | 0.73 |
| | | styrene-sulfonate | | | | | | |

The resin properties of Examples 5 to 7 and Comparative Examples 5 to 7 are properties of the shell agent and external additive.

was processed with a wet high-pressure emulsification machine to prepare a mold releasing agent particle dispersion having a volume average particle size of 102 nm.

Preparation of pigment particle

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of resin particle

| | |
|---|---|
| Styrene | 300 g |
| Butyl acrylate | 36.0 g |
| Acrylic acid | 4.5 g |
| Dodecanethiol | 13.5 g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 811.2 g of ion exchanged water. After being sealed with nitrogen, when the temperature was increased to 75° C., 20 g of a 10% ammonium persulfate solution was added thereto. Thereafter, the monomer dispersion was added dropwise over 3 hours.

Preparation of coagulated particle

| | |
|---|---|
| Resin particle dispersion | 426 g |
| Wax particle dispersion | 64 g |
| Coloring agent dispersion | 64 g |

After being sealed with nitrogen, the foregoing materials were mixed. 10 g of a 10% ammonium persulfate solution was added at 50° C. while adequately stirring, and thereafter, 50 g of a 10% iron (II) sulfate aqueous solution was gently added. As a result of keeping at 50° C. for 1 hour and at 60° C. for 1 hour while gently stirring, a coagulated particle having a volume average particle size of 5.1 μm was obtained.

Preparation of resin particle for capsule

| | | |
|---|---|---|
| Styrene | 295.55 | g |
| Butyl acrylate | 36 | g |
| Sodium styrenesulfonate | 4.5 | g |
| 2-Ethylhexyl 3-mercaptopropionate ester | 13.5 | g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 35,000 was obtained.

Preparation of Encapsulated Particle

50 g of a 10% aluminum sulfate aqueous solution was gently added at 50° C. while adequately stirring. As a result of keeping at 50° C. for 1 hour and at 55° C. for 1 hour while gently stirring, a hetero-coagulated particle having a volume average particle size of 5.2 μm was obtained.

Preparation of Fused Particle

The foregoing encapsulated particle dispersion was heated to 75° C. while weakly stirring and kept for 30 minutes.

Preparation of Toner Particle

The foregoing fused particle was allowed to stand, separated from a supernatant and then repeatedly subjected to washing with ion exchanged water and filtration. After thoroughly removing the moisture, the resulting particle was dried by a vacuum dryer for 10 hours to obtain a toner particle having a volume average particle size of 5.2 μm. 3 parts by weight of silica (manufactured by Nippon Aerosil Co., Ltd.) and

Preparation of mold releasing agent particle

| | |
|---|---|
| Rice wax (melting point: 80° C., manufactured by Toakasei | 100 g |
| Co., Ltd.) | |
| Anionic surfactant (Neogen SC-A manufactured by | 10 g |
| Dai-ichi Kogyo Seiyaku Co., Ltd.) | |
| Ion exchanged water | 390 g |

The foregoing materials were dispersed while heating at about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of pigment particle

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of coagulated particle

| | |
|---|---|
| Polyester resin particle dispersion | 382 g |
| Pigment particle dispersion | 34 g |
| Mold releasing agent dispersion | 73 g |

The foregoing materials were uniformly dispersed by using a homogenizer (manufactured by IKA Japan K.K.), 10 g of a 10% aluminum sulfate aqueous solution was additionally added, and the mixture was kept at 60° C. for 1 hour while gently stirring, to obtain a coagulated particle having a volume average particle size of 5.4 μm.

Preparation of resin particle for capsule

| | | |
|---|---|---|
| Styrene | 300 | g |
| Butyl acrylate | 36 | g |
| Sodium p-styrenesulfonate | 0.045 | g |
| 2-Ethylhexyl 3-mercaptopropionate ester | 13.5 | g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 37,000 was obtained.

Preparation of Encapsulated Particle 50 g of a 10% aluminum sulfate aqueous solution was gently added at 50° C. while adequately stirring. As a result of keeping at 50° C. for 1 hour and at 55° C. for 1 hour while gently stirring, a hetero-coagulated particle having a volume average particle size of 5.6 μm was obtained.

Preparation of Fused Particle

The foregoing encapsulated particle dispersion was heated to 75° C. while gently stirring and kept for 30 minutes.

Preparation of Toner Particle

The foregoing fused particle was allowed to stand, separated from a supernatant and then repeatedly subjected to washing with ion exchanged water and filtration. After thoroughly removing the moisture, the resulting particle was dried by a vacuum dryer for 10 hours to obtain a dry particle having a volume average particle size of 5.6 μm. As a result of observing a cross-section of this dry particle by SEM, a continuous and uniform capsule structure was confirmed. 3% by weight of silica (manufactured by Nippon Aerosil Co., Ltd.) and 0.5% by weight of titanium oxide (manufactured by Ishihara Sangyo Kaisha, Ltd.) were added based on 100% by weight of this dry particle, and the mixture was externally added by a Henschel mixture (manufactured by Mitsui Mining Co., Ltd.) to obtain a toner having a mold releasing agent content of 15%.

### Comparative Example 7

Polyester, capsule
High in environmental change
Preparation of resin particle

| | |
|---|---|
| Polyester resin | 100 g |
| (Bisphenol A-terephthalic acid adduct, Tg = 61° C., | |
| Mw = 13,000) | |
| Methylene chloride (manufactured by Wako Pure Chemical | 200 g |
| Industries, Ltd.) | |

The foregoing materials were dissolved and dispersed; the dispersion was dispersed in 357 g of ion exchanged water containing 40 g of polyethylene glycol (manufactured by Wako Pure Chemical Industries, Ltd.) and 3 g of an anionic surfactant (Neogen SC-A, manufactured by Dai-ichi Kogyo Seiyaku Co., Ltd.); and an O/W emulsion dispersion was prepared by using a homogenizer (manufactured by IKA Japan K.K.) and then heated to 60° C. to remove the methylene chloride, thereby preparing a resin particle dispersion having a volume average particle size of 500 nm.

Preparation of mold releasing agent particle

| | |
|---|---|
| Rice wax (melting point: 80° C., manufactured by Toakasei | 100 g |
| Co., Ltd.) | |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed while heating to about 90° C. by using a homogenizer (manufactured by IKA Japan K.K.), and the dispersion was processed with a wet high-pressure emulsification machine to prepare a mold releasing agent particle dispersion having a volume average particle size of 102 nm.

Preparation of pigment particle

| | |
|---|---|
| Carbon black (manufactured by Cabot Corporation) | 100 g |
| Anionic surfactant (Neogen SC-A, manufactured by Dai- | 10 g |
| ichi Kogyo Seiyaku Co., Ltd.) | |
| Ion exchanged water | 390 g |

The foregoing materials were dispersed by using a homogenizer (manufactured by IKA Japan K.K.) to prepare a coloring agent dispersion having a volume average particle size of 150 nm.

Preparation of coagulated particle

| | |
|---|---|
| Polyester resin particle dispersion | 382 g |
| Coloring agent dispersion | 34 g |
| Mold releasing agent dispersion | 73 g |

The foregoing materials were uniformly dispersed by using a homogenizer (manufactured by IKA Japan K.K.), 10 g of ion exchanged water containing aluminum sulfate was additionally added, and the mixture was kept at 50° C. for 1 hour while gently stirring to obtain a coagulated particle having a volume average particle size of 5.4 μm.

Preparation of resin particle for capsule

| | | |
|---|---|---|
| Styrene | 295.55 | g |
| Butyl acrylate | 36 | g |
| Sodium styrenesulfonate | 4.5 | g |
| 2-Ethylhexyl 3-mercaptopropionate ester | 13.5 | g |

The foregoing materials were mixed, the mixture was dispersed and emulsified in a solvent prepared by dissolving 1.8 g of a nonionic surfactant (Sannonic SS-70, manufactured by Sanyo Chemical Industries, Ltd.) and 3 g of an anionic surfactant (Neogen SC-A, manufactured by Dai-ichi Kogyo Seiyaku Co., Ltd.) in 820 g of ion exchanged water. After being sealed with nitrogen, the temperature was increased to 75° C., and 20 g of a 10% ammonium persulfate solution was added thereto. After stirring at 75° C. for 4 hours, 10 g of a 10% ammonium persulfate solution was added. As a result of emulsion polymerization at 75° C. for 7 hours, an emulsified resin particle dispersion having a volume average particle size of 100 nm, Tg of 60° C., and Mw of 35,000 was obtained.

Preparation of Encapsulated Particle

50 g of a 10% aluminum sulfate aqueous solution was gently added at 50° C. while adequately stirring. As a result of keeping at 50° C. for 1 hour and at 55° C. for 1 hour while gently stirring, a hetero-coagulated particle having a volume average particle size of 5.6 μm was obtained.

Preparation of Fused Particle

The foregoing encapsulated particle dispersion was heated to 75° C. while weakly stirring and kept for 30 minutes.

Preparation of Toner Particle

The foregoing fused particle was allowed to stand, separated from a supernatant and then repeatedly subjected to washing with ion exchanged water and filtration. After thoroughly removing the moisture, the resulting particle was dried by a vacuum dryer for 10 hours to obtain a toner particle having a volume average particle size of 5.6 μm. 3 parts by weight of silica (manufactured by Nippon Aerosil Co., Ltd.) and 0.5 parts by weight of titanium oxide (manufactured by Ishihara Sangyo Kaisha, Ltd.) were added based on 100 parts by weight of this dry particle, and the mixture was externally added by a Henschel mixture (manufactured by Mitsui Mining Co., Ltd.) to obtain a toner having a mold releasing agent content of 15%.

Evaluation of Environmental Change

The resulting electrophotographic toner and carrier were allowed to stand in low temperature low humidity (at 10° C. and 20%) and high temperature high humidity (at 30° C. and 85%) environments, respectively for 8 hours or more. After standing, 5 parts by weight of the electrophotographic toner and 95 parts by weight of the carrier were mixed in a plastic container, stirred for 30 minutes by a tumbler, shaker or mixer and measured for charge quantity by a suction type blow-off (TTB-200, manufactured by Kyocera Chemical Corporation). The charge quantity of the toner which had been allowed to stand under the low temperature low humidity environment (hereinafter referred to as “q/m [L/L]”) was 35.0; and the charge quantity of the toner which had been allowed to stand under the high temperature high humidity environment (hereinafter referred to as “q/m [H/H]”) was 33.2. An environmental change rate was calculated as an index of the environmental stability of charge quantity according to the following expression. As a result, it was found to be 0.95 in Example 1. When the environmental change rate is 0.80 or more, a satisfactory image can be obtained regardless of the environmental atmosphere.

Environmental Change Rate=q/m [H/H]/q/m [L/L]

Since each of the resin particles for toner or/and toner external additive of Examples 1 to 5 contains a trace amount of a sulfonic acid derivative, it is satisfied with both high yield and high charge quantity due to low water absorption amount and low environmental change. As the reasons why the environmental change properties in the toners of Examples 1 to 4 are improved, it is thought that by introducing a trace amount of a sulfonic group into the resin in place of the large amount of a carboxyl group, the acid value is decreased, and excellent dispersion stability is obtained due to the sulfonic group with strong polarity even when its amount is a trace amount, whereby both high yield and low environmental change could be satisfied. In Examples 6 to 7, by encapsulating the resin particle of Example 1 on the core agent of a resin composition having a relatively high acid value, excellent environmental stability is obtained.

Also, in the resin particles for toner or/and resin particles for external additive of Examples 1 to 5, as a result of adding an infinitesimal amount of a sulfonic acid derivative in the formulation in place of the large amount of a carboxylic acid derivative, an effect for reducing the cost is revealed.

### Evaluation of Water Content of Coagulated Resin Particle

As illustrated in the following Table 1, 2 g of saturated brine was added in 10 g of a resin latex obtained by emulsion polymerization, and the mixture was allowed to stand for coagulation at 55° C. for 1 hour, and then washed with 500 g of distilled water while sucking at 0.1 MPa by using No. 2 filter paper, followed by drying for 30 minutes.

TABLE 1
Water content of resin
(Formulation)

| | | |
|---|---|---|
| Latex | 10 | g |
| Saturated brine | 29 | g |
| Heating temperature | 55° | C. |
| Washing water | 500 | g |
| Suction drying time | 30 | minutes |

1 g of the resulting cake was taken and measured for water content by using a water content analyzer manufactured by Kensei Kogyo Co., Ltd. Since each of the resin particles for toner or/and toner external additive of Examples 1 to 5 contains a trace amount of a sulfonic acid derivative, high yield and water content of not more than 35% were revealed. In particular, in Examples 1 to 3 and 5, since a sulfonic acid derivative in a trace amount of about 135 ppm relative to the monomer was used, the water content was not more than 31 wt %. When a toner was produced by using a resin having such a water content of not more than 35%, a toner having an excellent environmental change rate was obtained.

The following Table 2 shows basic monomers, polar group derivatives and their contents, yields, water contents and results of environmental change rates in Examples and Comparative Examples.

Additionally, in Example 1, sodium styrenesulfonate was used as a dispersant. In Example 2, a sulfuric acid based dispersion stabilizer was used in place of sodium styrenesulfonate. In Example 3, different sulfuric acid based dispersion stabilizer from that in Example 2 was used. In Example 4, sodium styrenesulfonate was added ten times more than in Example 1. In Example 5, a methyl methacrylate monomer was used instead of a styrene monomer, and thus a satisfactory yield was revealed. In Example 6, encapsulation was carried out. In Example 7, a resin particle of the invention was coagulated on the surface of a core of a polyester resin particle to form a coating resin layer.

In Comparative Example 1, sodium styrenesulfonate was added in relatively large amount, and the water absorption was high, which was revealed 35.67%. In Comparative Example 2, an acrylic acid was decreased in amount. In Comparative Example 3, a large amount of acrylic acid was added, and thus the water absorption became high, 32.25%. In Comparative Example 4, the amount of sodium styrenesulfonate was 0.1 times the amount in Example 1. In Comparative Example 5, the amount of acrylic acid was 0.1 times the amount in Example 5, and thus the water absorption was increased to 36.27%. In Comparative Example 6, sodium styrenesulfonate added to the resin particle for capsule was 100 times the amount in Example 6, and thus the environmental change rate became high. In Comparative Example 7, sodium styrenesulformate added to the resin particle for capsule was 100 times the amount in Example 7, and thus the environmental change rate became high.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent comprising:
a coloring agent and a binder resin represented by the following structural formula (1): 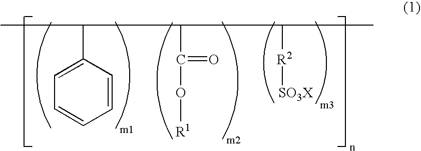
wherein n represents an integer; m1=60 to 90%, m2=10 to 40%, m3=1 ppm to 10%, while satisfying m1+m2+m3=100%; R¹ is hydrogen or a C1 to C18 alkyl group; R² is a cyclic compound having not lass than 6 of carbon number, or a C1 to C18 alkyl group; and X is an atom selected from the group consisting of hydrogen, sodium, potassium, and ammonium.

2. The developing agent according to claim 1, comprising a coagulated particle obtained by mixing a particle dispersion of the binder resin represented by the structural formula (1) with a particle dispersion containing the coloring agent, and coagulating the mixture.

3. The developing agent according to claim 1, comprising an encapsulated particle having the coagulated particle and a coating resin layer provided on a surface of the coagulated particle.

4. A preparation method of a developing agent comprising:
performing polymerization with the use of a binder resin dispersion including 60 to 90 mol % of a styrene monomer, 1 ppm to 10 mol % of a compound having one or more unsaturated bond and a sulfonic acid or sulfonate, and 10 to 40 mol % of an acrylic ester monomer.

5. The preparation method according to claim 4, comprising forming a coagulated particle by coagulating a dispersion containing a binder resin particle polymerized with the use of the binder resin dispersion, and a dispersion containing a coloring agent particle.

6. The preparation method according to claim 4, further comprising forming an encapsulated particle by applying a dispersion of a coating resin particle to a preliminarily prepared dispersion containing the coagulated particle, and coagulating the coating resin particle on a surface of the coagulated particle to form a coating resin layer.
